(19) United States
(12) Patent Application Publication
(10) Pub. No.: US 2021/0071023 A1
(43) Pub. Date: Mar. 11, 2021

(54) CYAN THERMAL INKJET DYE SUBLIMATION INKS

(71) Applicant: HEWLETT-PACKARD DEVELOPMENT COMPANY, L.P., Spring, TX (US)

(72) Inventors: Howard Doumaux, San Diego, CA (US); Nicholas J. Stewart, San Diego, CA (US)

(21) Appl. No.: 16/608,374

(22) PCT Filed: Nov. 8, 2017
(86) PCT No.: PCT/US2017/060684

§ 371 Date: Oct. 25, 2019

(51) Int. Cl. C09D 11/328; C09D 11/38; C09D 17/00; C08K 5/053; C08K 5/17; C08K 5/521; C08K 5/42; D06P 5/28; D06P 5/30; D06P 1/16

(52) U.S. Cl. CPC C09D 11/328; C09D 11/38; C09D 17/003; C08K 5/053; D06P 1/16; C08K 5/521; C08K 5/42; D06P 5/006; D06P 5/30; C08K 5/175

(57) ABSTRACT

A thermal inkjet dye sublimation ink consists of a cyan disperse dye colorant dispersion, glycerol, a water soluble or water miscible organic solvent, a chelating agent, additive(s), and water. The colorant dispersion is present in an amount ranging from about 1 wt % actives to about 7 wt % actives. Glycerol is present in an amount ranging from about 10 wt % to about 22 wt %, and the water soluble or miscible organic solvent is present in an amount ranging from 0 wt % to about 7 wt %. The chelating agent is present in an amount greater than 0 wt % actives and less than 0.1 wt % actives. The additive is selected from the group consisting of a buffer, a biocide, a surfactant, and combinations thereof.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers, and in particular piezoelectric inkjet printers, are gaining rapid acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating two examples of a printing method,

FIG. 2 is a partially cross-sectioned perspective semi-schematic illustration showing an example of heating resistors of an example thermal inkjet printhead;

FIG. 3 is a partially cross-sectioned perspective semi-schematic illustration showing an example of ink chambers of an example thermal inkjet printhead;

FIG. 4 is a partially cross-sectioned perspective semi-schematic illustration showing an example of a nozzle plate of an example thermal inkjet printhead;

FIG. 5 is a perspective view of an example of a thermal inkjet cartridge;

FIG. 6 is a schematic diagram of two examples of a printing system;

FIGS. 7A and 7B are graphs depicting the average drop velocity in meters per second (FIG. 7A) and the average drop weight in nanograms (FIG. 7B) at various printhead life stages in terms of millions of drops per nozzle (MDPN) for a comparative cyan ink;

FIGS. 8A and 8B are graphs depicting the average drop velocity in meters per second (FIG. 8A) and the average drop weight in nanograms (FIG. 8B) at various printhead life stages in terms of millions of drops per nozzle (MDPN) for an example cyan ink including a chelating agent;

FIGS. 9A and 9B are graphs depicting the average drop velocity in meters per second (FIG. 9A) and the average drop weight in nanograms (FIG. 9B) at various printhead life stages in terms of millions of drops per nozzle (MDPN) for another example cyan ink including a chelating agent;

FIGS. 10A and 10B are graphs depicting the average drop velocity in meters per second (FIG. 10A) and the average drop weight in nanograms (FIG. 10B) at various printhead life stages in terms of millions of drops per nozzle (MDPN) for yet another example cyan ink including a chelating agent;

FIGS. 11A and 11B are graphs depicting the average drop velocity in meters per second (FIG. 11A) and the average drop weight in nanograms (FIG. 11B) at various printhead life stages in terms of millions of drops per nozzle (MDPN) for an example cyan ink including a chelating agent and a jetting aid;

FIGS. 12A and 12B are graphs depicting the average drop velocity in meters per second (FIG. 12A) and the average drop weight in nanograms (FIG. 12B) at various printhead life stages in terms of millions of drops per nozzle (MDPN) for another example cyan ink including a chelating agent and a jetting aid;

FIGS. 13A and 13B are graphs depicting the average drop velocity (FIG. 13A) and the average drop weight in nanograms (FIG. 13B) at various printhead life stages in terms of millions of drops per nozzle (MDPN) for still another example cyan ink including a chelating agent and a jetting aid;

FIGS. 14A and 14B are graphs depicting the average drop velocity in meters per second (FIG. 14A) and the average drop weight in nanograms (FIG. 14B) at various printhead life stages in terms of millions of drops per nozzle (MDPN) for yet another example cyan ink including a chelating agent and a jetting aid; and

FIGS. 15A and 15B are graphs depicting the average drop velocity in meters per second (FIG. 15A) and the average drop weight in nanograms (FIG. 15B) at various printhead life stages in terms of millions of drops per nozzle (MDPN) for still another example cyan ink including a chelating agent and a jetting aid.

### DETAILED DESCRIPTION

Thermal inkjet printing involves electrically activating a resistor, which causes the resistor to heat rapidly and vaporize a thin film of the ink adjacent to the resistor, thereby ejecting a drop of ink from the printhead. The thermal interaction between the resistor and the ink can limit the type of ink that can be printed via thermal inkjet printheads. This type of thermal interaction is not involved in piezoelectric inkjet printing, and this may be one reason that dye sublimation inks have generally been formulated for piezoelectric printing. Furthermore, piezoelectric printheads are able to efficiently operate for long periods in the presence of high valence (e.g., 2⁺, 3⁺) metal salts and other organic impurities that may be present in the dye sublimation ink formulation.

Examples of the cyan dye sublimation ink disclosed herein are particularly suitable for thermal inkjet printing, in part because they include either a chelating agent or a specific combination of the chelating agent and oleth-3-phosphate (a jetting agent). It has unexpectedly been found that the chelating agent alone, or in combination with the oleth-3-phosphate, at very low levels (in total, less than 1 wt % of the inks) are able to counteract high valence (2⁺, 3⁺) metal salts and other organic impurities introduced from the cyan disperse dye colorant dispersion that could otherwise deleteriously affect the thermal inkjet printhead. The high valance (e.g., 2⁺, 3⁺) metal salts (e.g., iron, calcium, aluminum) are present in the cyan inks disclosed herein at levels ranging from about 4 ppm to about 10 ppm, which are well above typical thermal inkjet inks. However, it has been found that the chelating agent, alone or in combination with the oleth-3-phosphate, at the low levels disclosed herein aid in making the dye sublimation ink jettable via thermal inkjet printheads and also provide substantially consistent print quality (i.e., 525% change in drop velocity and/or in drop weight, and in some instances <15% change in drop velocity and/or drop weight) over the life of the printhead (e.g., from over 100 million drops per nozzle to 1 billion drops per nozzle). It has been found that the inks disclosed herein can extend the printhead life by two to three orders of magnitude when compared to inks that do not include the specific combination of a chelating agent and oleth-3-phosphate. This means that better print quality, e.g., prints without banding, missing spaces, and/or misdirected drops, can be achieved for a longer period of time using the inks disclosed herein.

In addition to having improved jettability from a thermal inkjet printhead, it is believed that the cyan dye sublimation ink disclosed herein is particularly suitable for directly forming an image on a textile substrate, such as polyester. The solvent levels used in the inks disclosed herein are relatively low (e.g., 22 wt % or less, and in some instances 16 wt % or less), which is believed to improve the storage ability of the prints formed via the direct printing method disclosed herein. After being printed, sublimed, and re-solidified, some disperse dyes can migrate across the textile substrate or within the fibers of the textile substrate when exposed to high temperature storage conditions (e.g., 38° C.). It is believed that the reduced amount of the solvents in the cyan inks disclosed herein can contribute to a reduced amount of residual solvent in the printed image, which improves dye re-solidification and reduces dye migration during storage.

An example of the thermal inkjet dye sublimation ink disclosed herein consists of a cyan disperse dye colorant dispersion present in an amount ranging from about 1 wt % actives to about 7 wt % actives based on a total weight of the ink; glycerol present in an amount ranging from about 10 wt % to about 22 wt % based on the total weight of the ink; a water soluble or water miscible organic solvent present in an amount ranging from 0 wt % to about 7 wt % based on the total weight of the ink; a chelating agent present in an amount greater than 0 wt % actives and less than 0.1 wt % actives based on the total weight of the ink; an additive selected from the group consisting of a buffer, a biocide, a surfactant, and combinations thereof; and a balance of water. In these examples, the thermal inkjet dye sublimation ink consists of the listed components and no additional components (such as shear thinning agents, additional solvents, etc.). In other examples, the thermal inkjet dye sublimation ink comprises the listed components, and other components that do not deleteriously affect the jettability of the cyan ink via a thermal inkjet printhead may be added.

Throughout this disclosure, a weight percentage that is referred to as “wt % actives” refers to the loading of an active component of a dispersion or other formulation that is present in the thermal inkjet dye sublimation ink. For example, the wt % actives of the cyan disperse dye colorant dispersion accounts for the loading (as a weight percent) of the active dye solids present in the ink, and does not account for the weight of the other components (e.g., co-solvent, water, etc.) of the disperse dye colorant dispersion in the inkjet ink. The term “wt %,” without the term actives, refers to the loading of a 100% active component that does not include other non-active components therein.

In the examples disclosed herein, the disperse dye colorant dispersion is cyan. Each disperse dye colorant dispersion includes a cyan disperse dye, a dispersant, and a dispersion vehicle.

Cyan disperse dye colorant dispersions may include blue disperse dyes, such as disperse blue 27, disperse blue 60, disperse blue 73, disperse blue 77, disperse blue 87, disperse blue 257, disperse blue 291:1, disperse blue 359, disperse blue 360, disperse blue 367, and mixtures thereof.

The disperse dye colorant dispersion may include from about 10 wt % dye solids to about 20 wt % dye solids based on the total weight of the colorant dispersion.

As mentioned above, the disperse dye colorant dispersion also includes a dispersant. The dispersant may be any suitable polymeric dispersant that can disperse the dye and that can be jetted via a thermal inkjet printhead.

Some examples of the polymeric dispersant (which may also be anionic or non-ionic) include polymers or copolymers of acrylics, methacrylics, acrylates, methacrylates, styrene, substituted styrene, α-methylstyrene, substituted α-methyl styrenes, vinyl naphthalenes, vinyl pyrollidones, maleic anhydride, vinyl ethers, vinyl alcohols, vinyl alkyls, vinyl esters, vinyl ester/ethylene copolymers, acrylamides, and/or methacrylamides. Some specific examples include a styrene methacrylic acid copolymer, a styrene acrylic acid copolymer, styrene acrylic acid-acrylic ester copolymers, styrene methacrylic acid-acrylic ester copolymers, a styrene maleic anhydride copolymer, polyacrylic acid partial alkyl ester, polyalkylene polyamine, polyacrylates, and vinyl naphthalene-maleic acid copolymers. Another example of a suitable polymeric dispersant is a polyurethane polymer. Still other examples of suitable polymeric dispersants for the disperse dye colorant dispersion include block acrylic copolymers, including A-B block copolymers such as benzyl methacrylate-methacrylic acid diblock copolymers and butyl methacrylate-methacrylic acid diblock copolymers. Still further examples of suitable polymeric dispersants include ABC triblock copolymers, such as benzyl methacrylate-methacrylic acid-ethoxytriethyleneglycol methacrylate triblock copolymers and butyl methacrylate-methacrylic acid-ethoxytriethyleneglycol methacrylate triblock copolymers. Still some other examples of suitable dispersants include low acid value acrylic resins, such as JONCRYL® 586, 671, 675, 678, 680, 683, 690, 693, and 695 (all from BASF Corp.).

Examples of polymerization methods used to form the dispersant may include free radical processes, Group Transfer Processes (GTP), radical addition fragmentation (RAFT), atom transfer reaction (ATR), special chain transfer polymerization technology (SCT), and the like. As one example, the dispersant may be a graft acrylic copolymer made by SCT.

In other examples, the disperse dyes may be self-dispersing dyes. The disperse dyes may be exposed to a diazonium treatment (where a charged free radical from a degraded azo attaches to the colorant), or to an ozone treatment (oxidation and functionalization with, e.g., a carboxylic acid), or to a crosslinking treatment to render the dye self-dispersing.

The disperse dye colorant dispersion may include from about 4 wt % dispersant solids to about 7 wt % dispersant solids, based on the total weight of the colorant dispersion.

The mean particle size of the solids (e.g., the disperse dyes and the dispersants) in the disperse dye colorant dispersion may range from about 50 nm to about 200 nm. In another example, the mean particle size of the disperse dye ranges from about 100 nm to about 200 nm. These particle sizes are particularly suitable for being jetted through the orifices of thermal inkjet printheads.

The dispersion vehicle may include water and a water soluble or water miscible co-solvent. Examples of the water soluble or water miscible co-solvent in the disperse dye colorant dispersion may include alcohols (e.g., diols, such as 1,2-propanediol, 1,3-propanediol, etc.), ketones, ketoalcohols, ethers (e.g., the cyclic ether tetrahydrofuran (THF), and others, such as thiodiglycol, sulfolane, 2-pyrrolidone, 1-(2-hydroxyethyl-2-pyrrolidone,1,3-dimethyl-2-imidazolidinone and caprolactam; glycols such as ethylene glycol, diethylene glycol, tritriethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

One or more of these co-solvents may be present in the disperse dye colorant dispersion in respective amounts ranging from about 1 wt % to about 5 wt %, based on the total weight of the colorant dispersion. The balance of the disperse dye colorant dispersion is water, such as purified water or deionized water.

In an example, the disperse dye colorant dispersion has i) a mean particle size ranging from about 50 nm to about 200 nm, and ii) from about 10 wt % dye solids to about 20 wt % dye solids and from about 4 wt % to about 7 wt % dispersant solids, based on the total weight of the colorant dispersion. In this example, the remainder of the disperse dye colorant dispersion may be co-solvent(s) and water.

As mentioned above, the chelating agent alone, or in combination with the oleth-3-phosphate, provides a synergistic effect within the ink that aids in making the dye sublimation ink jettable via thermal inkjet printheads and also results in substantially consistent print quality over the life of the thermal inkjet printhead. As such, disclosed herein is a method for improving thermal inkjet printing performance of a dye sublimation ink, comprising: selecting a chelating agent from the group consisting of methylglycinediacetic acid, trisodium salt; 4,5-dihydroxy-1,3-benzenedisulfonic acid disodium salt monohydrate; ethylenediaminetetraacetic acid; hexamethylenediamine tetra(methylene phosphonic acid), potassium salt; and combinations thereof; and incorporating the chelating agent into the dye sublimation ink, including a cyan disperse dye colorant dispersion present in an amount ranging from about 1 wt % actives to about 7 wt % actives based on a total weight of the ink; glycerol present in an amount ranging from about 10 wt % to about 22 wt % based on the total weight of the ink; a water soluble or water miscible organic solvent present in an amount ranging from 0 wt % to about 7 wt % based on the total weight of the ink; a chelating agent present in an amount greater than 0 wt % actives and less than 0.1 wt % actives based on the total weight of the ink; an additive selected from the group consisting of a buffer, a biocide, a surfactant, and combinations thereof; and a balance of water. When the combination of the chelating agent and the oleth-3-phosphate is used, this example of the method also includes selecting oleth-3-phosphate as the surfactant; and including the oleth-3-phosphate in an amount ranging from about 0.1 wt % to about 0.75 wt % based on the total weight of the ink.

To form examples of the thermal inkjet dye sublimation ink disclosed herein, the cyan disperse dye colorant dispersion is incorporated into an ink vehicle, which includes the glycerol, the water soluble or water miscible organic solvent, the chelating agent, additive(s), and water. To form other examples of the thermal inkjet dye sublimation ink, the oleth-3-phosphate is also included in the ink vehicle.

The cyan disperse dye colorant dispersion may be incorporated into the ink vehicle such that from about 1 wt % actives to about 7 wt % actives are present, based on a total weight of the thermal inkjet dye sublimation ink. In another example, the cyan disperse dye colorant dispersion may be present in an amount ranging from about 3 wt % actives to about 5 wt % actives based on the total weight of the thermal inkjet dye sublimation ink. The wt % actives of the cyan disperse dye colorant dispersion accounts for the loading (as a weight percent) of the active cyan dye solids present in the ink, and does not account for the weight of the other components (e.g., co-solvent, water, etc.) of the cyan disperse dye colorant dispersion in the inkjet ink.

Glycerol is the primary solvent, in part, because the disperse dye is highly non-soluble in glycerol. Glycerol is also selected, in part, because it also helps to maintain the nozzle health of the thermal inkjet printheads, and to provide substantially consistent print quality over the life of the printhead. The glycerol is present in an amount ranging from about 10 wt % to about 22 wt % based on the total weight of the ink. In an example, the glycerol is present in an amount ranging from about 12 wt % to about 16 wt % based on the total weight of the ink.

The ink also includes the water soluble or water miscible organic solvent present in an amount ranging from 0 wt % to about 7 wt % based on the total weight of the ink. In general, the cyan disperse dye in the cyan disperse dye colorant dispersion is more soluble in the water soluble or water miscible organic solvent than in the glycerol, and thus makes up less than 50% of the total solvent content (i.e., glycerol plus the water soluble or water miscible organic solvent, and not including water) so that the cyan disperse dyes remains dispersed in the ink vehicle. The water soluble or water miscible organic solvent may be added to the ink vehicle or may be included as the co-solvent from the cyan disperse dye colorant dispersion. The co-solvent(s) is present in the cyan disperse dye colorant dispersion in relatively low amounts (1 wt % to about 5 wt % based on the total weight of the colorant dispersion), and thus a fraction of the co-solvent(s) is carried over to the ink disclosed herein depending, in part, upon the dispersion solids and the loading of the dispersion in the ink. Examples of the water soluble or water miscible organic solvent that may be present in the cyan ink are selected from the group consisting of ethoxylated glycerol, 1,2-propanediol, 1,3-propanediol, dipropylene glycol, 2-pyrrolidone, 2-methyl-1,3-propanediol, tetrahydrofuran, diethylene glycol, and combinations thereof.

The chelating agent is present in an amount greater than 0 wt % actives and less than 0.1 wt % actives based on the total weight of the ink. In an example, the chelating agent is present in an amount ranging from about 0.04 wt % actives to about 0.08 wt % actives based on the total weight of the ink. The wt % actives of the chelating agent accounts for the loading (as a weight percent) of the active chelator/chelating agent present in the ink, and does not account for the weight of other components of the chelating agent solution (e.g., water) in the cyan inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); and hexamethylenediamine tetra(methylene phosphonic acid), potassium salt; and combinations thereof. Methylglycinediacetic acid, trisodium salt (Na₃MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals. It is believed that the chelating agent effectively traps high levels of the metal ions present in the ink. When included with oleth-3-phosphate, the chelating agent may also keep the oleth-3-phosphate from precipitating out of the ink.

The oleth-3-phosphate, when included, may be present in an amount ranging from about 0.1 wt % to about 0.75 wt % based on the total weight of the cyan ink. In an example, the oleth-3-phosphate is present in an amount ranging from about 0.2 wt % to about 0.5 wt % based on the total weight of the ink. Oleth-3-phosphate is commercially available as CRODAFOS™ O3A or CRODAFOS™ N-3 acid from Croda. It is believed that the oleth-3-phosphate aids the chelating agent in effectively trapping high levels of the metal ions present in the ink, and that the chelating agent keeps the oleth-3-phosphate from precipitating out of the ink. This combination leads to a significant and unexpected reduction in kogation in the thermal inkjet printhead. Kogation refers to the deposit of dried ink on a heating element of a thermal inkjet printhead, and the combination of the oleth-3-phosphate with the chelating agent assists in preventing the buildup of kogation and extending the life of the printhead. These synergistic effects were unexpected given the small amount of the two components and the relatively high level of metal ions present.

The thermal inkjet dye sublimation ink disclosed herein also includes an additive selected from the group consisting of a buffer, a biocide, a surfactant (which may be the oleth-3-phosphate), and combinations thereof.

In an example, the pH of the thermal inkjet dye sublimation ink ranges from about 7 to about 9.5 at the time of manufacture. In another example, the pH of the thermal inkjet dye sublimation ink ranges from about 8 to about 9 at the time of manufacture. The pH may drop from about 0.5 units to about 1 unit over time after being manufactured. As such, the pH of the inks disclosed herein may be lower than the ranges set forth herein, depending, in part, upon how much time has passed since manufacture. pH adjuster(s), such as a buffer, may be added to the ink to counteract any slight pH drop that may occur over time. In an example, the total amount of buffer(s) in the ink ranges from 0 wt % to about 0.5 wt % (with respect to the weight of the thermal inkjet dye sublimation ink). In another example, the total amount of buffer(s) in the ink is about 0.1 wt % (with respect to the weight of the thermal inkjet dye sublimation ink). Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of biocide(s) in the thermal inkjet dye sublimation ink ranges from about 0 wt % actives to about 0.5 wt % actives (with respect to the weight of the thermal inkjet dye sublimation ink). In another example, the total amount of biocide(s) in the inkjet ink composition is about 0.001 wt % actives to about 0.1 wt % actives (with respect to the weight of the thermal inkjet dye sublimation ink). The wt % actives of the biocide accounts for the loading (as a weight percent) of the active biocidal agent present in the ink, and does not account for the weight of other components of the biocide (e.g., water) in the inkjet ink.

Examples of suitable biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT), and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of surfactant(s) in the thermal inkjet dye sublimation ink ranges from about 0 wt % to about 2 wt % (with respect to the weight of the thermal inkjet dye sublimation ink). In another example, the surfactant is present in an amount of 1 wt % or less. In some examples, the surfactant is the previously described oleth-3-phosphate, and is present in an amount ranging from about 0.1 wt % to about 0.75 wt % based on the total weight of the ink. In other examples, the surfactant is a non-ionic, low foaming surfactant, such as an ethoxylated surfactant. In still other examples, the surfactant is a combination of the oleth-3-phosphate and the non-ionic ethoxylated surfactant. The non-ionic, low foaming surfactant may be included in the thermal inkjet dye sublimation ink to control the viscosity, to improve the lubricity, and to prevent agglomeration of the dispersed dye solids. Examples of suitable non-ionic, low foaming surfactants include ethoxylated 2,4,7,9-tetramethyl 5 decyn-4,7-diol (commercially available as SURFYNOL® 465 (HLB 13) from Evonik Industries) and other ethoxylated surfactants (commercially available as SURFYNOL®440 (HLB 8) from Evonik Industries), or secondary alcohol ethoxylates (commercially available as TERGITOL®15-S-7 (HLB 12.1), TERGITOL®15-S-9 (HLB 12.6), etc. from The Dow Chemical Co.). In some examples, it has been found that the combination of SURFYNOL® 465 and SURFYNOL® 440 may contribute to the synergistic effects of the inks disclosed herein in terms of wetting.

It is to be understood that water is not considered a solvent or co-solvent in the cyan inks disclosed herein, but rather is present in addition to the glycerol and the water soluble or water miscible organic solvent(s) and makes up a balance of the cyan ink. As such, the weight percentage of the water present in the thermal inkjet dye sublimation inks will depend, in part, upon the weight percentages of the other components. The water may be purified or deionized water.

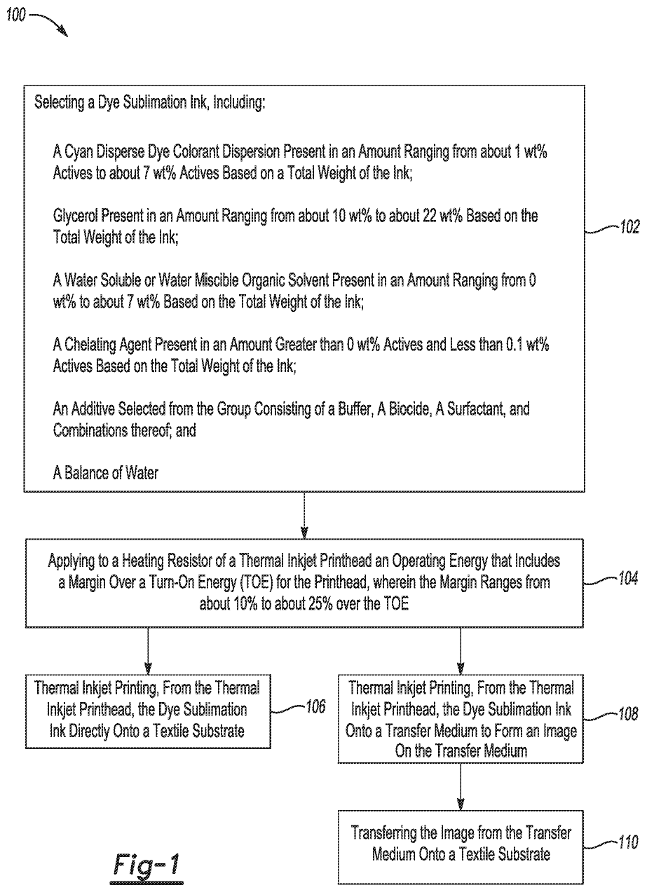

Referring now to FIG. 1, examples of the dye sublimation ink disclosed herein may be dispensed from a thermal inkjet printhead during examples of the printing method 100. One example of the method 100 (for direct printing) is shown at reference numerals 102, 104 and 106. Another example of the method 100 (for transfer printing) is shown at reference numerals 102, 104, 108, and 110.

The one example of the method 100 shown at reference numerals 102 and 104 includes selecting a dye sublimation ink, including: a cyan disperse dye colorant dispersion present in an amount ranging from about 1 wt % actives to about 7 wt % actives based on a total weight of the ink; glycerol present in an amount ranging from about 10 wt % to about 22 wt % based on the total weight of the ink; a water soluble or water miscible organic solvent present in an amount ranging from 0 wt % to about 7 wt % based on the total weight of the ink; a chelating agent present in an amount greater than 0 wt % actives and less than 0.1 wt % actives based on the total weight of the ink; an additive selected from the group consisting of a buffer, a biocide, a surfactant, and combinations thereof; and a balance of water (as shown at reference numeral 102); applying to a heating resistor of a thermal inkjet printhead an operating energy that includes a margin over a turn-on energy (TOE) for the printhead, wherein the margin ranges from about 10% to about 25% over the TOE (as shown at reference numeral 104); and thermal inkjet printing, from the thermal inkjet printhead, the dye sublimation ink directly onto a textile substrate (as shown at reference numeral 106). Any examples of the cyan ink disclosed herein may be used in this example of the method 100, and in one example, the cyan disperse dye in the cyan disperse dye colorant dispersion is more soluble in the water soluble or water miscible solvent than in the glycerol.

The textile substrate may be polyester fabric, a polyester coated surface, blends of polyester and other materials (e.g., cotton, linen, etc.) as long as polyester is present in an amount of at least 50 wt % and is present at or near the surface of the fabric, nylons, or other fabrics. In one example, the polyester blend includes from about 70 wt % to about 80 wt % of the polyester. Examples of materials that may be coated with polyester include glass, metal, wood, plastics, ceramics, etc.

With direct printing onto the textile, the dye sublimation ink is thermally inkjetted onto the surface of the textile substrate (reference numeral 106). A thermal inkjet printhead uses a certain minimum energy to fire ink drops of the proper volume (herein called the turn-on energy). To accommodate various manufacturing tolerances, it may be desirable to deliver more energy to the average printhead than is required to fire it (called “over-energy”) in order to allow for any uncertainty. However, it has been found that the cyan inks disclosed herein can be printed at an operating energy that includes a margin over the turn-on energy (TOE) for the printhead, wherein the margin ranges from about 10% to about 25% over the TOE. In an example, the margin is about 15% over the TOE. The low over-energy printing may also contribute to the improved performance of the cyan inks disclosed herein.

Once the dye sublimation ink disclosed herein is thermal inkjet printed directly on the textile, the textile may be exposed to heat, or heat and pressure. The heat, or heat and pressure is sufficient to sublimate the disperse dye so that it converts to a gas and penetrates into the textile. The heat, or heat and pressure may also be sufficient to open up the fibers of the textile substrate and allow the dye to migrate into the fibers. The dye then re-solidifies on the fibers of the textile substrate, which renders the printed image durable, wash-resistant, and colorfast. The heat to initiate sublimation may range from about 182° C. to about 215° C., and the pressure may range from 0 psi to about 100 psi.

The other example of the method 100 shown at reference numerals 102, 104, 108 and 110 includes selecting a dye sublimation ink, including: a cyan disperse dye colorant dispersion present in an amount ranging from about 1 wt % actives to about 7 wt % actives based on a total weight of the ink; glycerol present in an amount ranging from about 10 wt % to about 22 wt % based on the total weight of the ink; a water soluble or water miscible organic solvent present in an amount ranging from 0 wt % to about 7 wt % based on the total weight of the ink; a chelating agent present in an amount greater than 0 wt % actives and less than 0.1 wt % actives based on the total weight of the ink; an additive selected from the group consisting of a buffer, a biocide, a surfactant, and combinations thereof; and a balance of water (as shown at reference numeral 102); applying to a heating resistor of a thermal inkjet printhead an operating energy that includes a margin over a turn-on energy (TOE) for the printhead, wherein the margin ranges from about 10% to about 25% over the TOE (as shown at reference numeral 104); thermal inkjet printing, from the thermal inkjet printhead, the dye sublimation ink onto a transfer medium to form an image on the transfer medium (as shown at reference numeral 108); and transferring the image from the transfer medium onto a textile substrate (as shown at reference numeral 110).

Any examples of the cyan ink disclosed herein may be used in this example of the method 100, and in one example, the cyan disperse dye in the cyan disperse dye colorant dispersion is more soluble in the water soluble or water miscible solvent than in the glycerol.

With transfer printing onto the textile substrate, the dye sublimation ink is thermally inkjetted onto the surface of a transfer medium (reference numeral 108). The desired final image may be printed as a mirror image or in reverse on the transfer medium. The transfer medium may be any substrate that will accept the ink and also facilitate the release of the ink. The transfer medium may be a coated paper (from 30 gsm to 150 gsm).

For printing on the transfer medium, the thermal inkjet printhead may be operated at the operating energy that includes a margin over the turn-on energy (TOE) for the printhead, wherein the margin ranges from about 10% to about 25% over the TOE.

The image on the transfer medium is then transferred to the desired textile substrate (reference numeral 110). To make the transfer, the printed on transfer medium is placed into contact with the textile substrate, and the two are exposed to heat, or heat and pressure to effect the sublimation. The transfer process may involve a heat press or a calender. In the heat press or calender, the printed transfer medium is brought into contact with the textile substrate that is to be imaged. The heat to initiate sublimation may range from about 182° C. to about 215° C., and the pressure may range from 0 psi to about 100 psi. The sublimated dye is converted to a gas and is able to penetrate into the textile substrate it is in contact with. The dye then re-solidifies on the fibers of the textile substrate, which renders the printed image durable, wash-resistant, and colorfast. The heat to initiate sublimation may range from about 182° C. to about 215° C., and the pressure may range from 0 psi to about 100 psi.

The cyan dye sublimation inks disclosed herein are jettable via thermal inkjet printheads and cartridges.

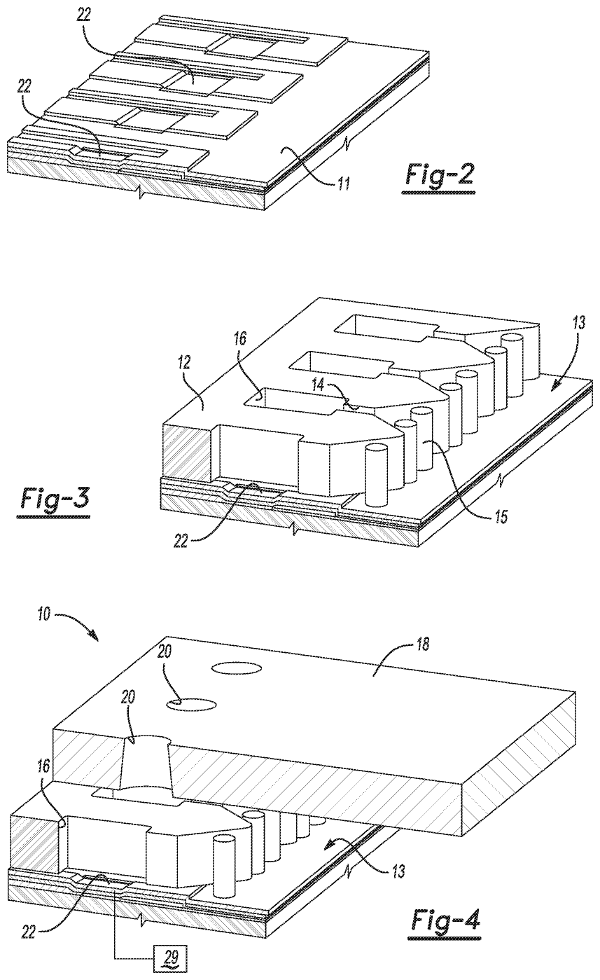

Referring now to FIGS. 2-5 together, an example thermal inkjet printhead 10 generally includes a base substrate 11 (made, e.g., from silicon or another suitable material). The base substrate 11 may include multiple layers (as shown in FIG. 2) to operatively accommodate suitable electronics to fire printhead nozzles. The printhead 10 further includes a substrate 12 (made, e.g., from a polymeric or other suitable material) defined on the base substrate 11. The substrate 12 has at least one ink feed opening 14 and at least one ink chamber/reservoir 16 defined therein. Four ink feed openings 14 are shown in FIG. 3, though it is to be understood that any desirable number of ink feed openings 14 may be provided. The ink feed opening 14 is in operative and fluid communication with an ink chamber 16 and with an ink channel 13. In an example, one or more pillars 15 may be positioned between the ink channel 13 and the ink feed opening 14 to filter the ink supply before it enters the ink chamber 16.

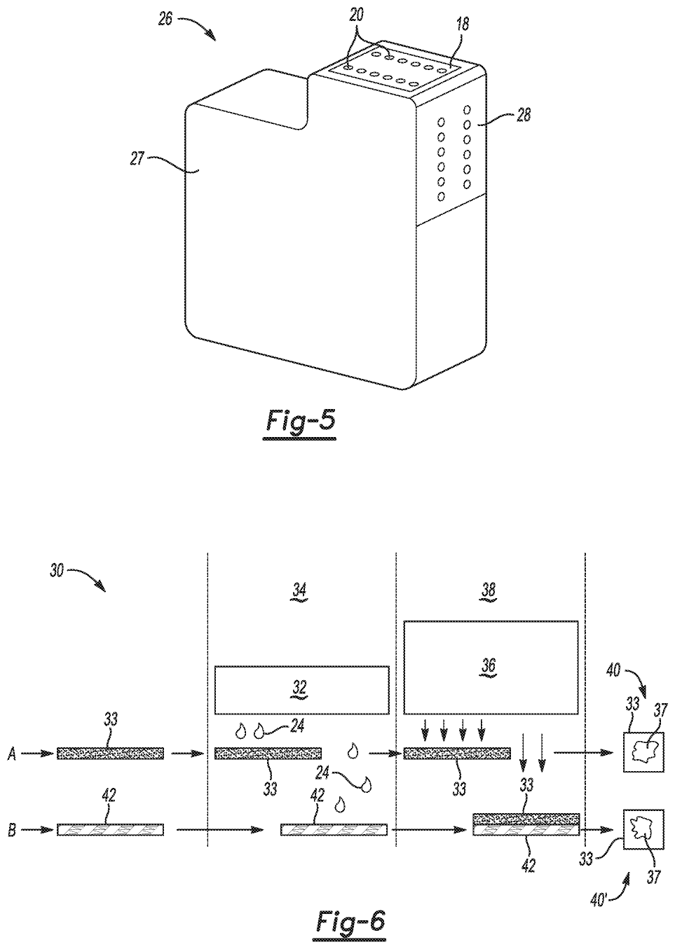

The ink chamber 16 is generally configured to repeatedly receive ink, via ink feed opening 14 and ink channel 13, from an ink supply or source during inkjet printing. In one example, the printhead 10 may be incorporated with an ink cartridge 26 (see FIG. 5), and the ink chamber 16 receives the ink from one or more ink supply regions housing, e.g., a volume of free ink and/or a capillary media configured to store the ink in individual capillaries. In another example, the printhead 10 may be a separate unit operatively connected (via appropriate tubing or the like) to a remotely located ink supply. In other words, printheads 10 can be integrated into the ink cartridge 26 (Integrated Print Head: IPH); or a printhead 10 can be integrated into a printer which has Individual Ink Cartridges (11C). It is to be understood that other configurations of the thermal inkjet printhead 10 are also contemplated herein.

The printhead 10 further includes a nozzle plate 18 disposed on the substrate 12. In an example, the nozzle plate 18 includes a plurality of orifices 20 (three of which are shown in FIG. 4). The orifice 20 is generally in fluid communication with the ink chamber 16 and is configured to eject an ink drop therethrough during an ink ejection process (i.e., the pushing of the ink out of the printhead 10 through the orifice 20 during thermal inkjet printing).

A heating/firing resistor 22 is operatively disposed on the base substrate 11 and proximate to the ink feed opening(s) 14 and ink chamber(s) 16. The heating/firing resistor 22 is also operatively associated with the orifice 20. Although FIG. 4 depicts that the heating/firing resistor 22 is operatively associated with a single orifice 20, it is to be understood that the resistor 22 may also be operatively associated with a plurality of orifices 20.

In an example of a thermal inkjet printhead 10, an array of ink chambers 16 receives liquid ink from the ink channel 13. The heating/firing resistor 22 is located opposite the nozzle/orifice 20 so that ink can collect between it and the orifice 20. The firing of ink droplets is typically under the control of a microprocessor (not shown), the signals of which are conveyed by electrical traces to the resistors 22. When electric printing pulses/electrical current is passed through the inkjet firing/heating resistor 22 to heat it to the desired firing temperature, a small portion of the ink next to it vaporizes and ejects a drop of ink from the printhead 10.

FIG. 5 is a semi-schematic illustration of an inkjet print cartridge 26 incorporating a printhead 10 according to an example. The inkjet print cartridge 26 includes an internal ink reservoir (not shown) within the cartridge body 27 and a printhead. The body 27 can include the ink reservoir wholly contained within the cartridge body 27 or, alternatively, can include a chamber inside the cartridge body 27 that is fluidly coupled to one or more off-axis ink reservoirs (not shown).

The printhead includes a nozzle plate 18 including orifices 20 formed in a flexible polymer circuit. The flexible circuit provides for the routing of conductive traces which are connected at one end to electrodes on the substrate and on the other end to contact pads 28. The print cartridge 26 is designed to be installed in a printer so that the contact pads 28 on the front surface of the flexible circuit contact printer electrodes, thereby providing externally generated energization signals to the printhead. Each resistor 22 may act as an ohmic heater when selectively energized by one or more pulses applied sequentially or simultaneously to one or more of the contact pads 28.

A printhead controller 29 is operatively connected to the heating resistor 22, to activate an electrical current to pass the electrical current through the heating resistor 22 to apply an operating energy that, in some examples, includes a margin over a turn-on energy (TOE) for the printhead 10, wherein the margin ranges from about 10% to about 25% over the TOE.

It is to be understood that a single printhead 10 may include multiple (e.g., 400 or some other desirable number) heating/firing resistors 22 and orifices 20. While not shown, it is to be understood that the printhead 10 includes an integrated circuit that selectively routes signals (e.g., from the microprocessor (operatively associated with the printhead controller 29) that is capable of running suitable computer readable instructions) to the desirable resistor(s) 22 and orifice(s) 20 for firing ink drops therefrom to produce images directly on the textile substrate or on a transfer medium.

The print cartridge 26 including the heating/firing resistor 22 may be mounted in a carriage of an inkjet printer (not shown). The carriage may move the print cartridge 26 across a print substrate (e.g., the textile substrate or the transfer medium) in a print/image zone of the printer. The orifice(s) 20 associated with the resistor 22 may be arranged in one or more linear orifice arrays. The orifice(s) 20 may be aligned parallel to the direction in which the print substrate is moved through the printer and perpendicular to the direction of motion of the resistor 22 with the print cartridge 26. Control of the ejection of thermal inkjet dye sublimation ink from each orifice 20 causes characters, or other images, to be printed in a swath across the textile substrate or the transfer medium.

Alternatively, the print cartridge 26 may be a page-wide print cartridge that is in fluid communication with an off-axis ink supply system. The page-wide print cartridge includes a print head bar that extends the entire print/image zone, and thus the page-wide print cartridge is static during a printing operation.

Referring now to FIG. 6, a schematic diagram of a printing system 30 including a thermal inkjet printer 32 in a printing zone 34 of the printing system 30 and a dryer 36 positioned in a sublimation zone 38 of the printing system 30.

In one example, a textile substrate 33 may be transported through the printing system 30 along the path shown by arrow A such that the textile substrate 33 is first fed to the printing zone 34 where an example of the cyan thermal inkjet dye sublimation ink 24 disclosed herein is inkjet printed directly onto the textile substrate 33 by the thermal inkjet printer 32 (for example from the printhead 10 as described above) to form an ink layer on the textile substrate 33. The ink layer disposed on the textile substrate 33 may be heated in the printing zone 34 (for example, the air temperature in the printing zone 34 may range from about 10° C. to about 90° C.) such that water may be at least partially evaporated from the ink layer. As an example, at least partial evaporation means that at least 50% of the water is removed. As another example, at least 80% of the water may be removed during evaporation. Generally, it is desirable for enough water to be removed from an area so that color in the area is not transferred to an adjacent portion/facing surface of the textile substrate 33 during/after rolling that comes in contact with the area. The textile substrate 33 (having the ink layer printed thereon) may then be transported to the sublimation zone 38 where the ink layer is heated or heated and exposed to pressure to sublimate the dye, causing it to penetrate into the textile substrate 33. This forms the printed article 40 including the image 37 formed on the textile substrate 33.

In another example, a transfer medium 42 may be transported through the printing system 30 along the path shown by arrow B such that the transfer medium 42 is first fed to the printing zone 34 where an example of the cyan thermal inkjet dye sublimation ink 24 disclosed herein is inkjet printed directly onto the transfer medium 42 by the thermal inkjet printer 32 (for example, from the printhead 10 as described above) to form an ink layer on the transfer medium 42. The transfer medium 42 (having the ink layer printed thereon) may then be transported to the sublimation zone 38 and placed into contact with the textile substrate 33. In the sublimation zone 38, the ink layer is heated or heated and exposed to pressure to sublimate the dye from the transfer medium 42, causing it to penetrate into the penetrable textile substrate 33. This forms the printed article 40′ including the image 37 formed on the textile substrate 33. Transfer printing is also known as blocking and/or backside transfer printing.

To further illustrate the present disclosure, an example is given herein. It is to be understood that this example is provided for illustrative purposes and is not to be construed as limiting the scope of the present disclosure.

### Example

A comparative cyan ink was prepared including no chelating agent or jetting aid.

Three example cyan inks (example inks A, B, C) were prepared including TRILON® M as the chelating agent, and without the jetting aid.

Five additional example inks (examples inks D, E, F, G, and H) were prepared with combinations of some chelating agent and oleth-3-phosphate as a jetting aid.

The formulations for comparative cyan ink and example inks A, B, and C are shown in Table 1. The formulations for example inks D, E, F, G, and H are shown in Table 2. The weight percentages given for the dye dispersion, the chelating agent, and the biocides represent wt % actives in the ink formulations.

TABLE 1

| | | Comp. | Example A | Example B | Example C |
|---|---|---|---|---|---|
| | | Cyan Ink | Cyan Ink | Cyan Ink | Cyan Ink |
| | Specific | Amount | Amount | Amount | Amount |
| Ingredient | Component | (wt %) | (wt %) | (wt %) | (wt %) |
| Dye | Cyan | 4.4 | 4.4 | 4.4 | 4.4 |
| Dispersion | Dispersion | | | | |
| Solvent | Glycerol | 20 | 20 | 20 | 12 |
| Surfactant | SURYNOL ® | 0.5 | 0.5 | 0.5 | 0.25 |
| | 465 | | | | |
| | SURYNOL ® | N/A | N/A | N/A | 0.25 |
| | 440 | | | | |
| Jetting Aid | Oleth-3- | N/A | N/A | N/A | N/A |
| (surfactant) | Phosphate | | | | |
| Chelating | TRILON ® | N/A | 0.04 | 0.08 | 0.08 |
| Agent | M | | | | |
| Buffer | TRIS | 0.1 | 0.1 | 0.1 | 0.1 |
| Biocide | ACTICIDE | 0.04 | 0.04 | 0.04 | 0.04 |
| | B20 | | | | |
| | ACTICIDE | 0.014 | 0.014 | 0.014 | 0.014 |
| | M20 | | | | |
| Water | | Balance | Balance | Balance | Balance |

TABLE 2

| | | Example | Example | Example | Example | Example |
|---|---|---|---|---|---|---|
| | | Cyan Ink D | Cyan Ink E | Cyan Ink F | Cyan Ink G | Cyan Ink H |
| | Specific | Amount | Amount | Amount | Amount | Amount |
| Ingredient | Component | (wt %) | (wt %) | (wt %) | (wt %) | (wt %) |
| Dye | Cyan Dispersion | 4.4 | 4.4 | 4.4 | 4.4 | 4.4 |
| Dispersion | | | | | | |
| Solvent | Glycerol | 12 | 12 | 12 | 12 | 12 |
| Surfactant | SURYNOL ® 465 | 0.25 | 0.25 | 0.25 | 0.25 | 0.25 |
| | SURYNOL ® 440 | 0.25 | 0.25 | 0.25 | 0.25 | 0.25 |
| Jetting Aid | Oleth-3- | 0.2 | 0.2 | 0.2 | 0.35 | 0.5 |
| (surfactant) | Phosphate | | | | | |
| Chelating | TRILON ® M | 0.04 | N/A | N/A | 0.08 | 0.08 |
| Agent | | | | | | |
| | TIRON | N/A | 0.02 | 0.04 | N/A | N/A |
| | monohydrate | | | | | |
| Buffer | TRIS | 0.1 | 0.1 | 0.1 | 0.1 | 0.1 |
| Biocide | ACTICIDE B20 | 0.04 | 0.04 | 0.04 | 0.04 | 0.04 |
| | ACTICIDE M20 | 0.014 | 0.014 | 0.014 | 0.014 | 0.014 |
| Water | | Balance | Balance | Balance | Balance | Balance |

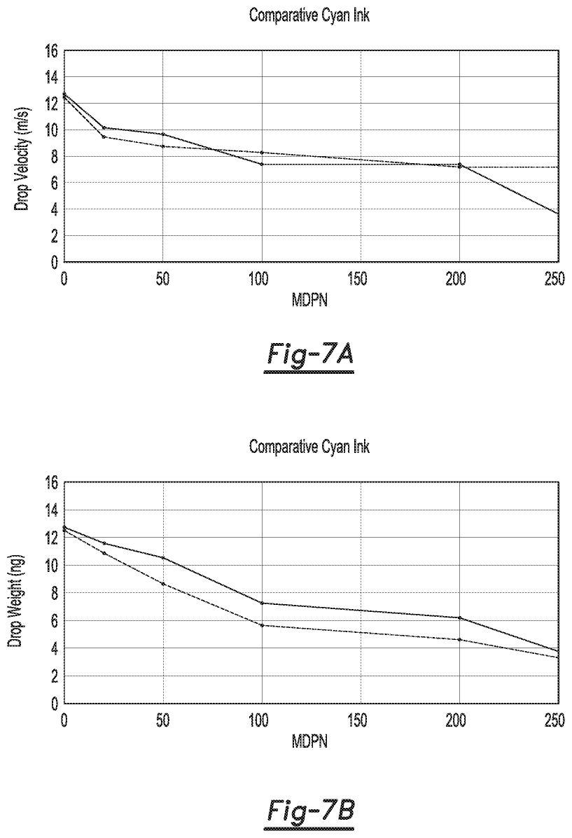

The comparative and example cyan inks were tested using HP 831 thermal inkjet color printheads and various test fixtures to repeatedly fire the printheads (at 15% over-energy) and to measure drop velocity (DV, in m/s) and drop weight (DW, in ng) at various life stages of the printheads, represented by millions of drops per nozzle (MDPN). Each of these values was taken at a given life stage, namely 0, 20, 50, 100, 200, and 300 MDPN. In FIGS. 7A, 7B, 8A, 8B, 9A, and 9B, the data points for 300 MDPN is not shown. Two tests were performed for each of the comparative and example inks, where the respective inks were printed from both sides of respective printheads.

The average drop velocity and average drop weight results for the comparative cyan ink are shown in FIGS. 7A and 7B, respectively. Without any chelating agent or oleth-3-phosphate, the comparative ink drop velocity and drop weight continuously declined over the life of the printhead. The performance significantly declined for three of the four tests after 200 MDPN.

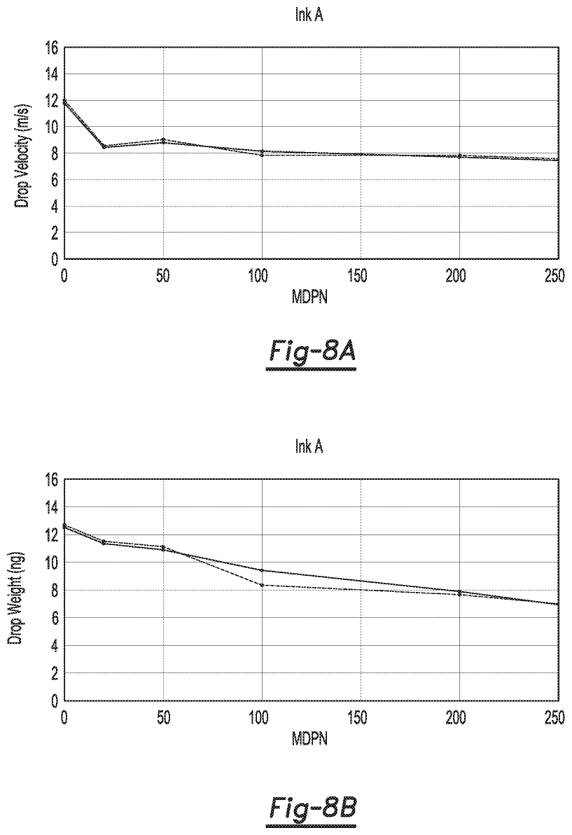

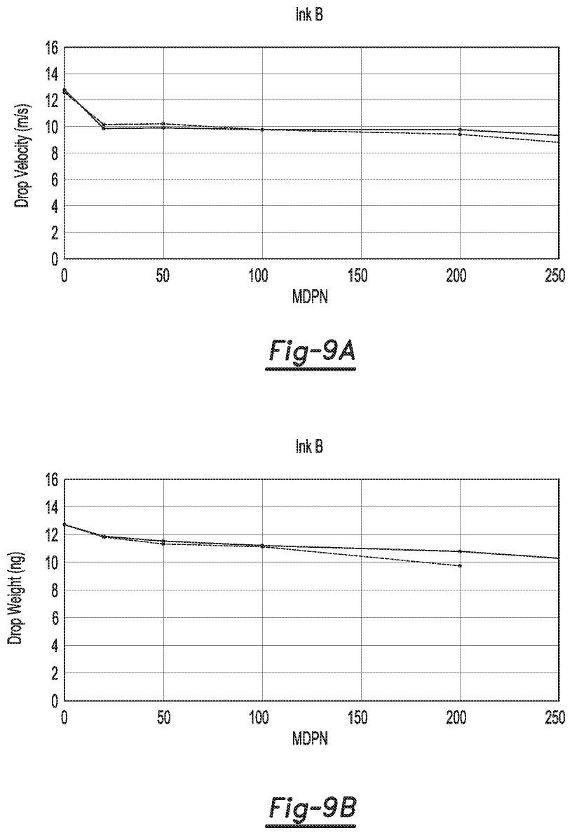

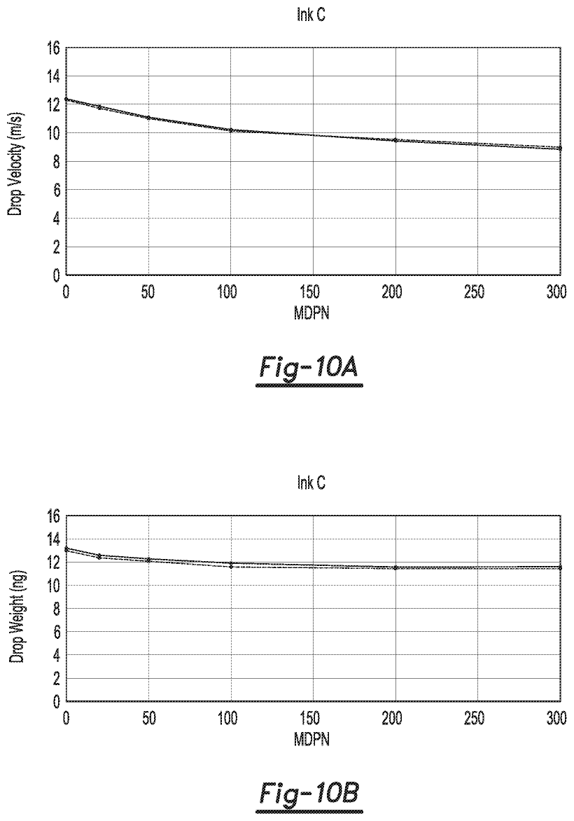

The average drop velocity and average drop weight results for the example inks A, B, and C (with chelating agent and no jetting aid) are shown in FIGS. 8A and 8B (ink A), FIGS. 9A and 9B (ink B), and FIGS. 10A and 10B (ink C). Cyan inks A, B, and C, with the added chelating agent, had more consistent drop velocity and weights compared to the comparative cyan ink over the life of the printheads. Moreover, the performance of inks A, B, and C was significantly improved between 200 and 250 MDPN. Comparing ink A (with 0.04 wt % TRILON® M chelating agent) with inks B and C (each of which had 0.08 wt % TRILON® M chelating agent), it appears the additional amount of the chelating agent generally improved both drop velocity and drop weight performance over the life of the printhead.

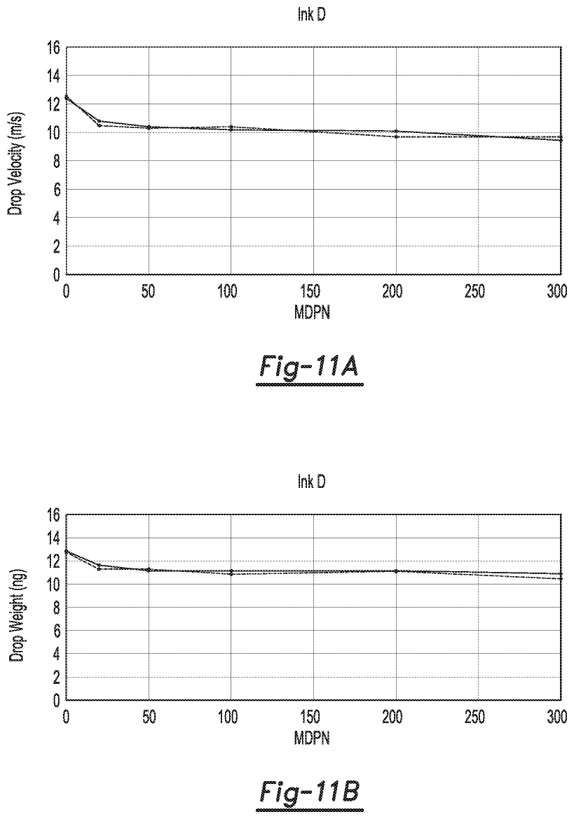

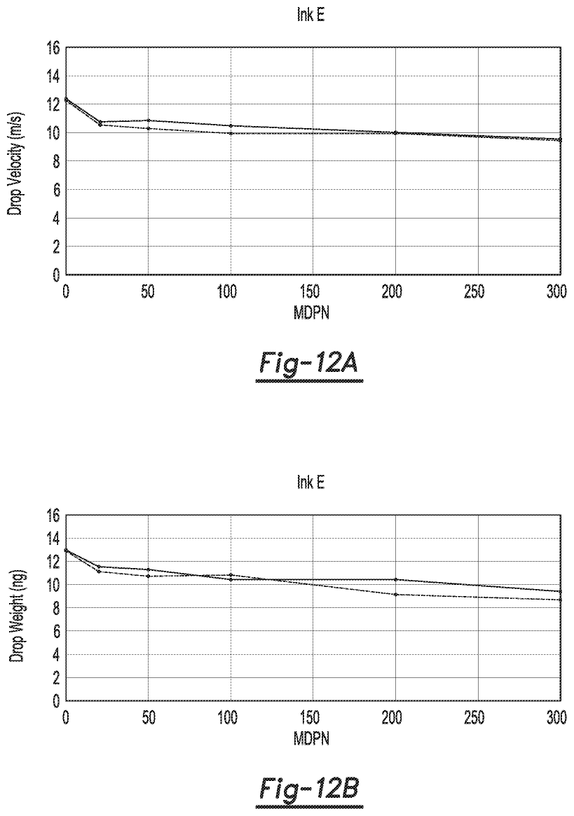

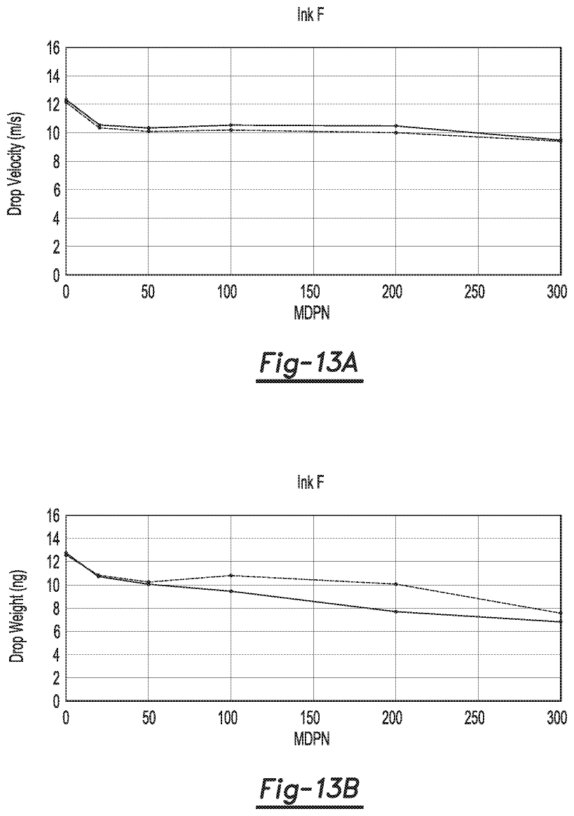

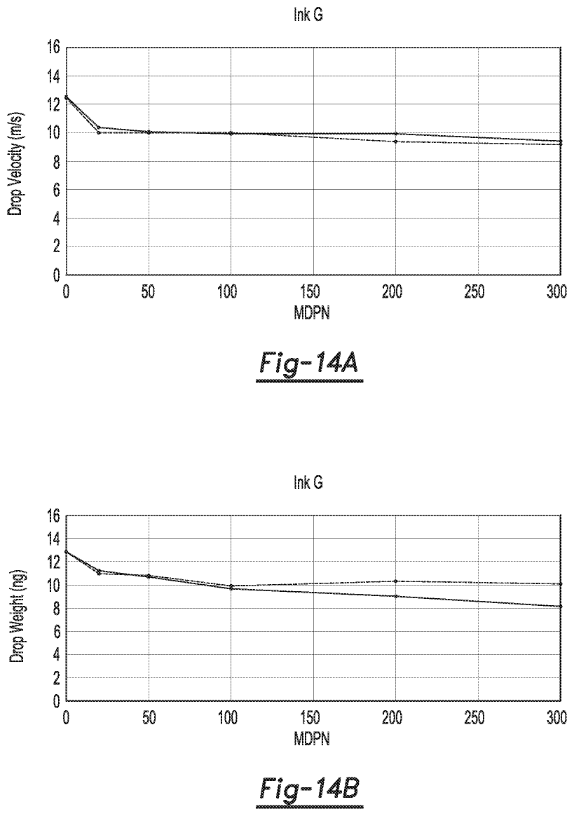

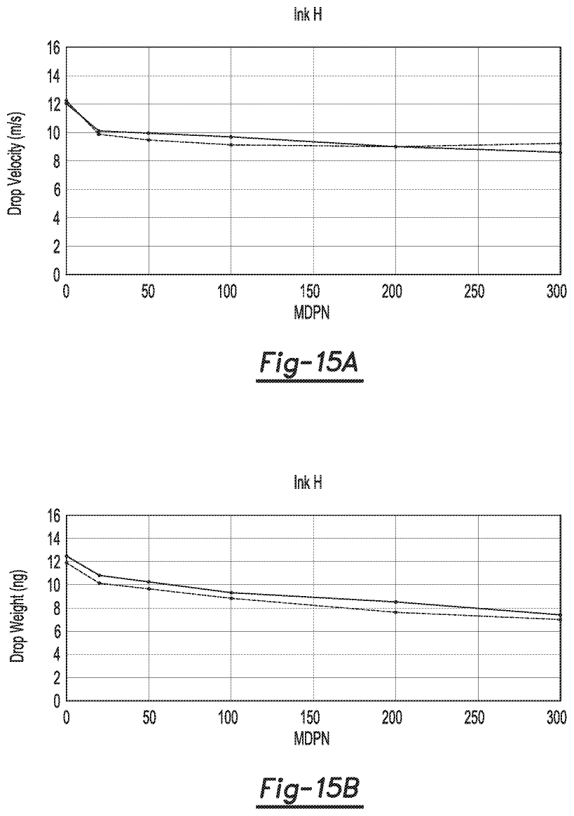

The average drop velocity and average drop weight results for the example inks D, E, F, G, and H (with chelating agent and jetting aid) are shown in FIGS. 11A and 11B (ink D), FIGS. 12A and 12B (ink E), FIGS. 13A and 13B (ink F), FIGS. 14A and 14B (ink G), and FIGS. 15A and 15B (ink H). Cyan inks D, E, F, G, and H, with the added chelating agent and the oleth-3-phosphate jetting aid, had more consistent drop velocity and weights compared to the comparative cyan ink (FIGS. 7A and 7B) over the life of the printheads. Moreover, the performance of inks D, E, F, G, and H was significantly improved between 50 and 300 MDPN.

Example ink D had the most consistent performance of all of the cyan inks that included both the chelating agent and the oleth-3-phosphate. The inks prepared with TIRON monohydrate (ink E and F) did not perform as consistently in terms of drop weight as the ink prepared with 0.04 wt % TRILON® M (ink D). Example inks G and H included more of the oleth-3-phosphate, which did not improve the results. While all of inks D through G performed better than the comparative cyan ink, inks D and E, each of which had the lowest amounts of both the chelating agent (TRILON® M in ink D and TIRON monohydrate in ink E) and the oleth-3-phosphate performed the best.

While the results are not shown, the nozzle health of the printheads used to print inks D through E was also evaluated. These results were consistent with the drop velocity and drop weight results, indicating that inks D and E performed the best.

It is to be understood that the ranges provided herein include the stated range and any value or sub-range within the stated range. For example, a range from about 10 wt % to about 22 wt % should be interpreted to include not only the explicitly recited limits of from about 10 wt % to about 22 wt %, but also to include individual values, such as 13 wt %, 17 wt %, 20.5 wt %, 21.8 wt %, etc., and sub-ranges, such as from about 12 wt % to about 17 wt %, from about 11 wt % to about 21 wt %, from about 14 wt % to about 16 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A thermal inkjet dye sublimation ink, consisting of:
a cyan disperse dye colorant dispersion present in an amount ranging from about 1 wt % actives to about 7 wt % actives based on a total weight of the ink;
glycerol present in an amount ranging from about 10 wt % to about 22 wt % based on the total weight of the ink;
a water soluble or water miscible organic solvent present in an amount ranging from 0 wt % to about 7 wt % based on the total weight of the ink;
a chelating agent present in an amount greater than 0 wt % actives and less than 0.1 wt % actives based on the total weight of the ink;
an additive selected from the group consisting of a buffer, a biocide, a surfactant, and combinations thereof; and
a balance of water.

2. The thermal inkjet dye sublimation ink as defined in claim 1 wherein the chelating agent is selected from the group consisting of methylglycinediacetic acid, trisodium salt; 4,5-dihydroxy-1,3-benzenedisulfonic acid disodium salt monohydrate; ethylenediaminetetraacetic acid; hexamethylenediamine tetra(methylene phosphonic acid), potassium salt; and combinations thereof.

3. The thermal inkjet dye sublimation ink as defined in claim 1 wherein the chelating agent is present in an amount ranging from about 0.04 wt % actives to about 0.08 wt % actives based on the total weight of the ink.

4. The thermal inkjet dye sublimation ink as defined in claim 1 wherein the cyan disperse dye is selected from the group consisting of disperse blue 27, disperse blue 60, disperse blue 73, disperse blue 77, disperse blue 87, disperse blue 257, disperse blue 359, disperse blue 360, disperse blue 367, and mixtures thereof.

5. The thermal inkjet dye sublimation ink as defined in claim 1 wherein the glycerol is present in an amount ranging from about 12 wt % to about 16 wt % based on the total weight of the ink.

6. The thermal inkjet dye sublimation ink as defined in claim 1 wherein the cyan disperse dye colorant dispersion has i) a mean particle size ranging from about 50 nm to about 200 nm, and ii) from about 10 wt % dye solids to about 20 wt % dye solids and from about 4 wt % to about 7 wt % dispersant solids, based on a total weight of the colorant dispersion.

7. The thermal inkjet dye sublimation ink as defined in claim 1 wherein the water soluble or water miscible organic solvent is selected from the group consisting of ethoxylated glycerol, 1,2-propanediol, 1,3-propanediol, dipropylene glycol, 2-pyrrolidone, 2-methyl-1,3-propanediol, tetrahydrofuran, diethylene glycol, and combinations thereof.

8. The thermal inkjet dye sublimation ink as defined in claim 1 wherein a cyan disperse dye in the cyan disperse dye colorant dispersion is more soluble in the water soluble or water miscible organic solvent than in the glycerol.

9. The thermal inkjet dye sublimation ink as defined in claim 1 wherein the surfactant is oleth-3-phosphate present in an amount ranging from about 0.1 wt % to about 0.75 wt % based on the total weight of the ink.

10. The thermal inkjet dye sublimation ink as defined in claim 1 wherein the surfactant is a combination of oleth-3-phosphate and a non-ionic ethoxylated surfactant.

11. A printing method, comprising:
selecting a dye sublimation ink, including:
a cyan disperse dye colorant dispersion present in an amount ranging from about 1 wt % actives to about 7 wt % actives based on a total weight of the ink;
glycerol present in an amount ranging from about 10 wt % to about 22 wt % based on the total weight of the ink;
a water soluble or water miscible organic solvent present in an amount ranging from 0 wt % to about 7 wt % based on the total weight of the ink;
a chelating agent present in an amount greater than 0 wt % actives and less than 0.1 wt % actives based on the total weight of the ink;
an additive selected from the group consisting of a buffer, a biocide, a surfactant, and combinations thereof; and
a balance of water; and
applying to a heating resistor of a thermal inkjet printhead an operating energy that includes a margin over a turn-on energy (TOE) for the printhead, wherein the margin ranges from about 10% to about 25% over the TOE; and
thermal inkjet printing, from the thermal inkjet printhead, the dye sublimation ink:
i) directly onto a textile fabric to form an image; or
ii) onto a transfer medium to form an image on the transfer medium; and
transferring the image from the transfer medium onto the textile substrate.

12. The method as defined in claim 11, further comprising exposing the image to a post-treatment process involving heat ranging from about 182° C. to about 215° C., and pressure ranging from 0 psi to about 100 psi.

13. A method for improving thermal inkjet printing performance of a dye sublimation ink, comprising:
selecting a chelating agent from the group consisting of methylglycinediacetic acid, trisodium salt; 4,5-dihydroxy-1,3-benzenedisulfonic acid disodium salt monohydrate; ethylenediaminetetraacetic acid; hexamethylenediamine tetra(methylene phosphonic acid), potassium salt; and combinations thereof; and
incorporating the selected chelating agent into the dye sublimation ink, including:
a cyan disperse dye colorant dispersion present in an amount ranging from about 1 wt % actives to about 7 wt % actives based on a total weight of the ink;
glycerol present in an amount ranging from about 10 wt % to about 22 wt % based on the total weight of the ink;
a water soluble or water miscible organic solvent present in an amount ranging from 0 wt % to about 7 wt % based on the total weight of the ink;
an additive selected from the group consisting of a buffer, a biocide, a surfactant, and combinations thereof; and
a balance of water;
wherein the incorporating involves adding the chelating agent present in an amount greater than 0 wt % actives and less than 0.1 wt % actives based on the total weight of the ink.

14. The method as defined in claim 13 wherein:
the chelating agent is selected from the group consisting of methylglycinediacetic acid, trisodium salt; 4,5-dihydroxy-1,3-benzenedisulfonic acid disodium salt monohydrate; ethylenediaminetetraacetic acid; hexamethylenediamine tetra(methylene phosphonic acid), potassium salt; and combinations thereof; and
the chelating agent is present in an amount ranging from about 0.04 wt % to about 0.08 wt % based on the total weight of the ink.

15. The method as defined in claim 13, further comprising:
selecting oleth-3-phosphate as the surfactant; and
including the oleth-3-phosphate in an amount ranging from about 0.1 wt % to about 0.75 wt % based on the total weight of the ink.
